(19) United States
(12) Patent Application Publication
(10) Pub. No.: US 2025/0112812 A1
(43) Pub. Date: Apr. 3, 2025

(54) CREST FACTOR REDUCTION SYSTEMS AND METHODS

(71) Applicant: Apple Inc., Cupertino, CA (US)

(72) Inventors: Adrian Ispas, Munich (DE); Robert Dallinger, Vienna (AT); Christoph Angerer, Sierning (AT); Christian Mayer, Wilhering (AT)

(21) Appl. No.: 18/734,903

(22) Filed: Jun. 5, 2024

Related U.S. Application Data
(60) Provisional application No. 63/586,333, filed on Sep. 28, 2023.

(51) Int. Cl. H04L 27/26

(52) U.S. Cl. CPC H04L 27/2623

(57) ABSTRACT

An electronic device may include crest factor reduction circuitry having a clip and filter block and a frequency shift block. The crest factor reduction circuitry may receive an input signal and generate an output signal based on the input signal. The output signal may have a reduced peak-to-average power ratio relative to the input signal. The electronic device may also include a transmitter coupled to the crest factor reduction circuitry and configured to transmit a radio frequency signal based on the output signal.

### CROSS-REFERENCE TO RELATED APPLICATIONS

This application claims priority to U.S. Provisional Application No. 63/586,333, filed Sep. 28, 2023, which is incorporated by reference herein in its entirety.

### BACKGROUND

This disclosure generally relates to crest factor reduction, such as in radio-frequency (RF) communication devices.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Numerous electronic devices—including televisions, portable phones, computers, wearable devices, vehicle dashboards, virtual—reality glasses, and more-utilize radio frequency (RF) circuitry to transmit and receive data. In general, RF circuitry (e.g., transmission circuitry) converts a modulated digital signal to an analog voltage, such as via a radio frequency digital-to-analog converter (RFDAC), for transmission via an antenna. In some scenarios, crest factor reduction (CFR) may be performed on the digital signal to reduce the peak-to-average power ratio (PAPR), which may allow for increased power output and/or efficiency during power amplification (e.g., prior to transmission via the antenna). However, CFR typically incurs tradeoffs such as increased error vector magnitude (EVM), which may reduce signal quality, and/or degraded adjacent carrier leakage ratio (ACLR), which may correspond to transmissions outside of a desired band or channel.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device may include crest factor reduction circuitry having a clip and filter block and a frequency shift block. The crest factor reduction circuitry may receive an input signal and generate an output signal based on the input signal. The output signal may have a reduced peak-to-average power ratio relative to the input signal. The electronic device may also include a transmitter coupled to the crest factor reduction circuitry and configured to transmit a radio frequency signal based on the output signal.

In another embodiment, a method may include receiving, via clip and filter circuitry of crest factor reduction circuitry, a first signal corresponding to data to be transmitted via transmission circuitry coupled to the crest factor reduction circuitry and clipping and filtering, via the clip and filter circuitry, the first signal to generate a second signal. The method may also include shifting, via frequency shift circuitry of the crest factor reduction circuitry, a frequency spectrum of the second signal to generate a third signal and clipping and filtering, via the clip and filter circuitry, the third signal to generate a fourth signal. Further, the method may include outputting the fourth signal.

In yet another embodiment, a non-transitory, machine-readable medium may include instructions that, when executed by one or more processors, cause the one or more processors to control signal processing circuitry to perform operations or to perform the operations. The operations may include receiving a first signal corresponding to data to be transmitted via transmission circuitry coupled to the one or more processors, the signal processing circuitry, or both. The operations may also include clipping and filtering the first signal to generate a second signal, shifting a frequency spectrum of the second signal to generate a third signal, clipping and filtering the third signal to generate a fourth signal, and outputting the fourth signal.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a block diagram of signal processing circuitry that includes a crest factor reduction (CFR) block coupled to the transmitter of FIG. 3, in accordance with an embodiment of the present disclosure;

FIG. 5 is a block diagram of an example CFR block of FIG. 4, including clip and filter blocks and a digital frequency shift (DFS) block, in accordance with an embodiment of the present disclosure;

FIG. 6 is a block diagram of a clip and filter block of FIG. 5, including a clipping sub-block and a filtering sub-block, in accordance with an embodiment of the present disclosure;

FIG. 7 is a graph of a power spectral density of a signal undergoing CFR, in accordance with an embodiment of the present disclosure;

FIG. 8 is a block diagram of an example CFR block of FIG. 4, including multiple CFR-DFS sets, in accordance with an embodiment of the present disclosure;

FIG. 9 is a graph of example adjacent carrier leakage ratios (ACLRs) for different arrangements of the CFR block of FIG. 4, in accordance with an embodiment of the present disclosure;

FIG. 10 is a graph of example error vector magnitudes (EVMs) for the different arrangements of a CFR block of FIG. 9, in accordance with an embodiment of the present disclosure;

FIG. 11 is a graph of example peak-to-average power ratios (PAPRs) for the different arrangements of a CFR block of FIG. 9, in accordance with an embodiment of the present disclosure; and

FIG. 12 is a flowchart of an example process for performing CFR via the CFR block of FIG. 4, in accordance with an embodiment of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

In general, electronic devices may utilize a radio frequency (RF) system (e.g., RF circuitry) to wirelessly communicate data with other electronic devices and/or a network by modulating radio waves at assigned transmission frequencies (e.g., bands), based on an analog representation of the data (e.g., the output RF signal). For example, the RF circuitry may convert a digital signal to an analog voltage, such as via a radio frequency digital-to-analog converter (RFDAC) and transmit the RF signal via an antenna. The analog voltage may be amplified (e.g., within the RFDAC and/or via power amplification circuitry) to increase a strength of the transmitted signal. However, certain properties of the signal to be transmitted, such as a relatively high peak-to-average power ratio (PAPR) may reduce the efficiency and/or efficacy of power amplification and, thus, reduce the output power (e.g., signal strength) of the transmitted RF signal. As such, in some scenarios, crest factor reduction (CFR) may be performed on the digital signal and/or analog signal (e.g., prior to amplification) to reduce the PAPR, which may allow for increased power output and/or efficiency during power amplification (e.g., prior to transmission via the antenna).

In some embodiments, a CFR block (e.g., CFR circuitry) of signal processing circuitry may be implemented to process an input signal (e.g., the digital signal or the analog signal) to reduce the PAPR. As should be appreciated, the blocks discussed herein, such as the CFR block, may be implemented digitally (e.g., in software via one or more processors) and/or implemented in hardware circuitry (e.g., dedicated hardware circuitry). Furthermore, as used herein, the input signal may be a digital signal or analog signal input into the CFR block for reduction of the PAPR, an intermediate signal may be any partially processed version/permutation of the input signal utilized within the CFR block, and an output signal may be the input signal processed by and output from the CFR block, having CFR applied. In some embodiments, the CFR block may clip and/or filter (e.g., via one or more clip and filter blocks) the input signal one or more times to reduce the PAPR thereof. For example, clipping the input signal may reduce peaks in the input signal according to a clipping threshold (e.g., power threshold). Additionally, filtering may be performed to reduce or remove undesirable frequency components within the input signal, which may be, at least in part, generated due to the clipping.

However, clipping and filtering techniques for CFR may incur tradeoffs such as increased error vector magnitude (EVM), which may reduce signal quality, and/or decrease an adjacent carrier leakage ratio (ACLR), which may increase transmissions outside of a desired band (e.g., transmission frequency, carrier frequency). For example, clipping and filtering may generate spurs within the output signal, which may be exasperated at low and/or non-centered (e.g., about a reference frequency) resource block (RB) allocations. As such, in some embodiments, a digital frequency shift (DFS) block may be implemented in conjunction with one or more clipping and filtering stages to improve the spectral emissions of the output signal. For example, the CFR block may shift the frequency spectrum of the input signal and/or an intermediate signal of the CFR block to be centered around a reference frequency (e.g., 0 Hz, the carrier frequency, a band frequency, or other suitable frequency). Moreover, in some scenarios, when implemented after one or more clip and filter blocks, the DFS block may reduce (e.g., correct) shifts of the spectral components of an intermediate signal into different bands (e.g., adjacent bands, neighboring channels), such as generated due to the clipping and/or filtering, which may improve (e.g., increase) ACLR. Additionally, in some scenarios, the use of the DFS block before one or more clip and filter blocks may suppress harmonics (e.g., spurs) that may otherwise be generated due to the clipping and/or filtering, which may improve (e.g., reduce) EVM. Furthermore, in some embodiments, both improvements may be realized by implementing the DFS block between one or more sets of clip and filter blocks. For example, one or more clip and filter blocks may be implemented before the DFS block and one or more additional clip and filter blocks may be implemented after the DFS block. As should be appreciated, one or more clip and filter blocks may be utilized before and/or after the DFS block, and different amounts and/or relative positions of the clipping, filtering, and DFS blocks may be utilized depending on implementation. Furthermore, while discussed herein as a digital frequency shift (e.g., via a DFS block, DFS circuitry, frequency shift circuitry), in some embodiments, such as those where CFR is implemented to an analog signal, the frequency shift may be implemented in the analog domain.

Additionally, in some embodiments, multiple sets of one or more clip and filter blocks and DFS blocks may be utilized in series. For example, in some embodiments, multiple DFS blocks that perform frequency shifts about different reference frequencies (e.g., carrier frequencies, band frequencies) may be utilized to perform CFR on per-component carrier (CC) basis, such as on an input signal that is carrier-aggregated. As such, frequency-specific CFR may be performed in stages (e.g., series) for improved EVM, ACLR, and/or PAPR. Moreover, in some scenarios, performing per-CC (e.g., frequency-specific) CFR may allow for reduced complexity of the associated filters (e.g., for each CFR stage).

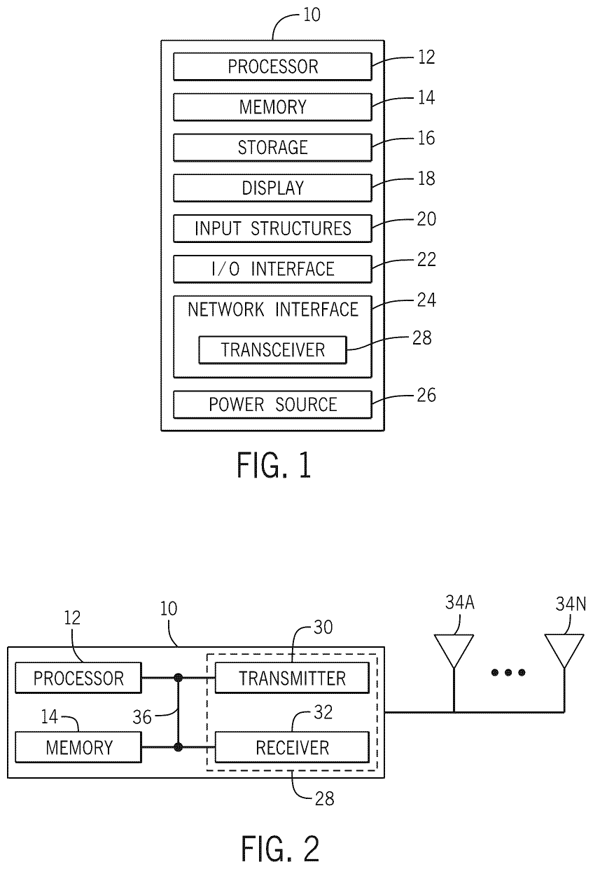

With the foregoing in mind, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 20, an input/output (I/O) interface 22, a network interface 24, and a power source 26. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 20, the input/output (I/O) interface 22, the network interface 24, and/or the power source 26 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 20 of the electronic device 10 may enable a user to interact with the electronic device 10 (e.g., pressing a button to increase or decrease a volume level). The I/O interface 22 may enable electronic device 10 to interface with various other electronic devices, as may the network interface 24. In some embodiments, the I/O interface 22 may include an I/O port for a hardwired connection for charging and/or content manipulation using a standard connector and protocol, such as the Lightning connector, a universal serial bus (USB), or other similar connector and protocol. The network interface 24 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 24 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 24 of the electronic device 10 may allow communication over the aforementioned networks (e.g., 5G, Wi-Fi, LTE-LAA, and so forth).

The network interface 24 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 24 may include a transceiver 28. In some embodiments, all or portions of the transceiver 28 may be disposed within the processor 12. The transceiver 28 may support transmission and receipt of various wireless signals via one or more antennas, and thus may include a transmitter and a receiver. Moreover, the transceiver 28 may include signal processing circuitry having a crest factor reduction block (e.g., crest factor reduction circuitry). In some embodiments, the crest factor reduction block may perform crest factor reduction on a signal (e.g., prior to amplification) to reduce the peak-to-average power ratio, which may allow for increased power output and/or efficiency during power amplification with improved spectral emissions. For example, the crest factor reduction block may include one or more clipping and one or more filtering blocks for reducing the peak-to-average power ratio and one or more digital frequency shift blocks for shifting the frequency spectrum of the signal to be centered (e.g., in the frequency domain) around a reference frequency to decrease error vector magnitude and/or improve the adjacent carrier leakage ratio, such as introduced via the clipping and/or filtering blocks. As such, frequency-specific crest factor reduction may be performed for improved error vector magnitude, adjacent carrier leakage ratio, and/or peak-to-average power ratio. Additionally, the power source 26 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 28, a transmitter 30, a receiver 32, and/or antennas 34 (illustrated as 34A-34N, collectively referred to as an antenna 34) may be communicatively coupled directly or indirectly (e.g., through or via another component, a communication bus, a network) to one another to transmit and/or receive signals between one another.

The electronic device 10 may include the transmitter 30 and/or the receiver 32 that respectively enable transmission and reception of signals between the electronic device 10 and an external device via, for example, a network (e.g., including base stations or access points) or a direct connection. As illustrated, the transmitter 30 and the receiver 32 may be combined into the transceiver 28. The electronic device 10 may also have one or more antennas 34A-34N electrically coupled to the transceiver 28. The antennas 34A-34N may be configured in an omnidirectional or directional configuration, in a single-beam, dual-beam, or multi-beam arrangement, and so on. Each antenna 34 may be associated with one or more beams and various configurations. In some embodiments, multiple antennas of the antennas 34A-34N of an antenna group or module may be communicatively coupled to a respective transceiver 28 and each emit radio frequency signals that may constructively and/or destructively combine to form a beam. The electronic device 10 may include multiple transmitters 30, multiple receivers 32, multiple transceivers 28, and/or multiple antennas 34 as suitable for various communication standards. In some embodiments, the transmitter 30 and the receiver 32 may transmit and receive information via other wired or wireline systems or means.

As illustrated, the various components of the electronic device 10 may be coupled together by a bus system 36. The bus system 36 may include a data bus, for example, as well as a power bus, a control signal bus, and a status signal bus, in addition to the data bus. The components of the electronic device 10 may be coupled together or accept or provide inputs to each other using some other mechanism.

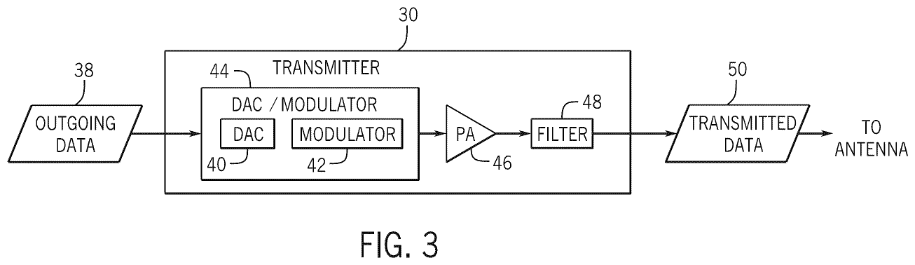

FIG. 3 is a schematic diagram of the transmitter 30 (e.g., transmit circuitry), according to embodiments of the present disclosure. As illustrated, the transmitter 30 may receive outgoing data 38 in the form of a digital signal to be transmitted via the one or more antennas 34. A digital-to-analog converter (DAC) 40 of the transmitter 30 may convert the digital signal to an analog signal, and a modulator 42 may combine the converted analog signal with a carrier signal to generate a radio wave. Additionally or alternatively, the DAC 40 and modulator 42 may be implemented together in a DAC/modulator 44. For example, the DAC/modulator 44 may convert the digital signal to the analog signal and combine the converted analog signal with the carrier signal simultaneously or concurrently and/or within the same circuitry. Moreover, the DAC/modulator 44 may be implemented as multiple circuits (e.g., DAC 40 and modulator 42) coupled together or a singular combined circuit. In some embodiments, the DAC/modulator 44 may directly generate a modulated analog signal without first generating the converted analog signal. Furthermore, as used herein, a DAC 40 may refer to a standalone DAC 40 (e.g., to be followed by a modulator 42) or a combined DAC/modulator 44, and an analog signal may refer to a converted analog signal or a modulated analog signal. Additionally, while embodiments are described herein as applying to RF signal generation, in some embodiments, aspects of the present disclosure may be applicable to other types or utilizations of DACs, such as a baseband DAC.

A power amplifier (PA) 46 receives the modulated signal from the modulator 42. The power amplifier 46 may amplify the modulated signal to a suitable level to drive transmission of the signal via the one or more antennas 34. A filter 48 (e.g., filter circuitry and/or software) of the transmitter 30 may then remove undesirable noise from the amplified signal to generate transmitted data 50 to be transmitted via the one or more antennas 34. The filter 48 may include any suitable filter or filters to remove the undesirable noise from the amplified signal, such as a bandpass filter, a bandstop filter, a low pass filter, a high pass filter, and/or a decimation filter. Additionally, the transmitter 30 may include any suitable additional components not shown, or may not include certain of the illustrated components, such that the transmitter 30 may transmit the outgoing data 38 via the one or more antennas 34. For example, the transmitter 30 may include a mixer and/or a digital up converter and/or the transmitter 30 may not include the power amplifier 46 and/or filter 48.

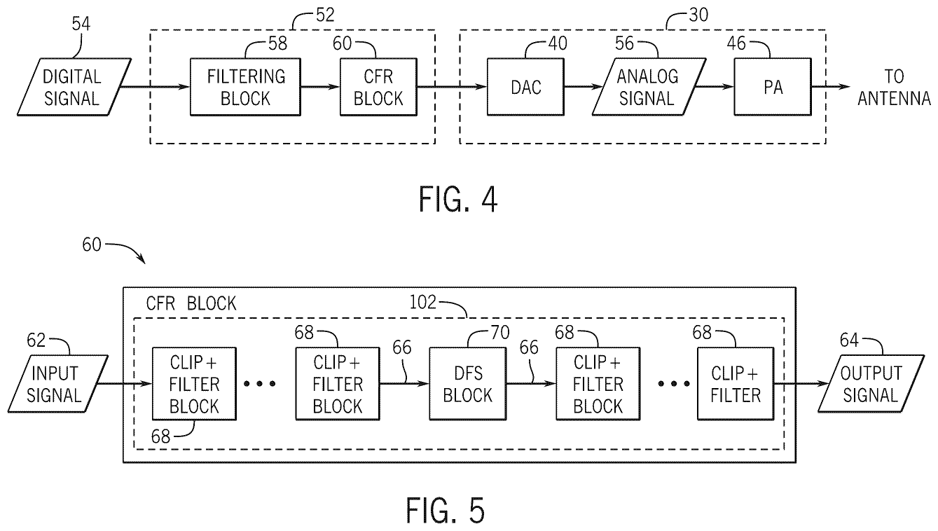

As discussed herein, the transmitter 30 may generate an analog signal indicative of the transmitted data 50 based on a digital representation of the outgoing data 38, such as generated, at least in part by the processor 12. In some embodiments, signal processing circuitry 52 may modify a digital signal 54 or an analog signal 56 of the DAC 40, such as via a filtering block 58 and/or a crest factor reduction (CFR) block 60 (e.g., CFR circuitry), as shown in the block diagram of FIG. 4. As should be appreciated, while the signal processing circuitry 52 of FIG. 4 is depicted as receiving the digital signal 54 and outputting to the transceiver 28, in some embodiments, the signal processing circuitry 52 may be included, at least in part, within the transceiver 28 and operate on the analog signal 56. For example, the filtering block 58 (e.g., filter 48) and/or CFR block 60 may be implemented in hardware circuitry to operate on the analog signal 56. Furthermore, in some embodiments, the signal processing circuitry 52 or portions thereof may be implemented before the transceiver 28, such as operating on the digital signal 54, and within the transceiver 28, such as operating on the analog signal 56. Moreover, as should be appreciated, the blocks discussed herein, such as the CFR block 60, may be implemented digitally (e.g., in software via one or more processors, such as processor 12), such as to operate on the digital signal 54 and/or implemented in hardware circuitry (e.g., dedicated hardware circuitry), such as to operate on the digital signal 54 and/or the analog signal 56.

As discussed above, the transceiver 28 may amplify (e.g., within the DAC 40 and/or via the power amplifier 46) the analog signal 56, such as to increase a strength (e.g., power) of the signal (e.g., of the transmitted data 50) transmitted via the antenna(s) 34. However, certain properties of the signal to be transmitted, such as the peak-to-average power ratio (PAPR) may reduce the efficiency and/or efficacy of power amplification and, thus, reduce the output power (e.g., signal strength) of the transmitted RF signal. As such, in some embodiments, the signal processing circuitry 52 may include a CFR block 60 to perform crest factor reduction on the digital signal 54 and/or analog signal 56 (e.g., prior to amplification) to reduce the PAPR, which may allow for increased power output and/or efficiency during power amplification. As should be appreciated, the signal processing circuitry 52 may include additional blocks such as a filtering block 58, including one or more signal filters (e.g., filter 48), modulation blocks (not shown), such as for imparting frequency modulation, and/or any suitable signal processing block for modifying the digital signal 54 and/or analog signal 56.

As discussed herein, the CFR block 60 of the signal processing circuitry 52 may process an input signal 62 (e.g., the digital signal 54 or the analog signal 56) to reduce the PAPR of an output signal 64 of the CFR block 60, as shown in the block diagram of FIG. 5. As used herein, the input signal 62 may be considered as the input into the CFR block 60, and the output signal 64 may be considered as the output from the CFR block 60, having CFR applied thereto. Moreover, an intermediate signal 66 may be considered as any partially processed version/permutation of the input signal 62 utilized within the CFR block 60.

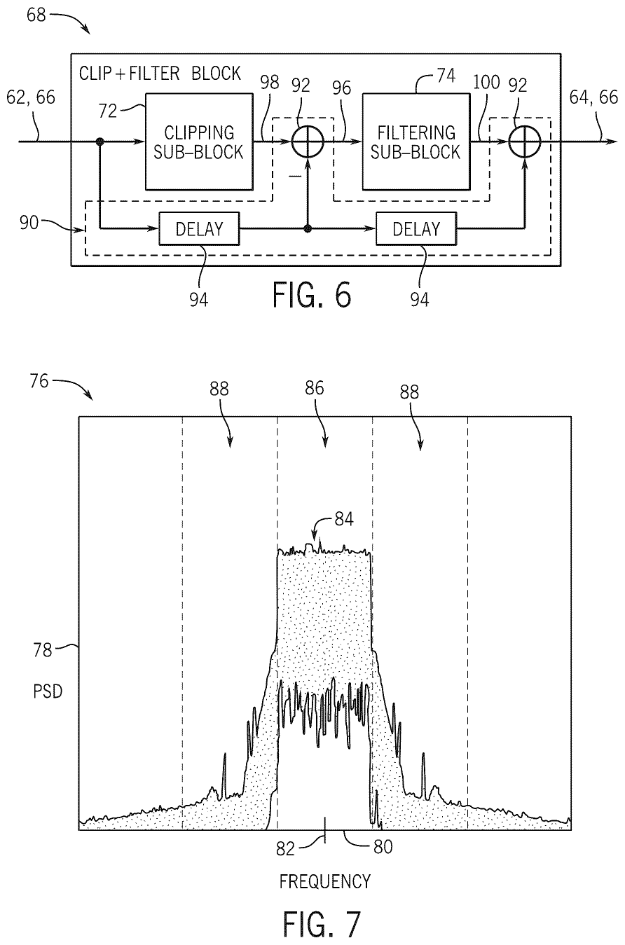

In some embodiments, the CFR block 60 may include one or more clip and filter blocks 68 (clip and filter circuitry) and a digital frequency shift (DFS) block 70 (e.g., DFS circuitry, frequency shift circuitry) to reduce the PAPR of the output signal 64, relative to the input signal 62. As discussed herein, while the clip and filter block(s) 68 may be used to reduce the PAPR of the output signal 64, the DFS block 70 may be utilized to reduce signal anomalies in the output signal 64 that may be associated with clipping and filtering. To help illustrate, FIG. 6 is a block diagram of a clip and filter block 68, including a clipping sub-block 72 and a filtering sub-block 74, and FIG. 7 is a graph 76 of a power spectral density (PSD) 78 (e.g., in decibels per Hertz (dB/Hz)) over a range of frequencies 80, for an input signal 62 or intermediate signal 66 centered about a reference frequency 82.

Clipping (e.g., via the clipping sub-block 72) the input signal 62 and/or an intermediate signal 66 may reduce peaks 84 in the power at different frequencies 80 according to a clipping threshold (e.g., power threshold) with respect to a time domain. For example, amplitudes (e.g., digital amplitude values or analog amplitudes) of the input signal 62 and/or an intermediate signal 66 above the clipping threshold 84, with respect to a time domain (e.g., as opposed to the frequency domain illustrated in FIG. 7), may be reduced to a value of the clipping threshold. As should be appreciated, the clipping threshold may be a set power value in the time domain across multiple frequencies 80 or vary with frequency 80, such as a set or variable threshold in the frequency domain, depending on implementation. Furthermore, in some embodiments, separate clip and filter blocks 68 may utilize the same or different clipping sub-blocks 72 for clipping at different amplitudes.

Additionally, filtering (e.g., via the filtering sub-block 74) may be performed to reduce or remove undesirable frequency components within the input signal 62 or intermediate signal 66, which, in some scenarios, may be, at least in part, generated due to the clipping. In some embodiments, separate clip and filter blocks 68 may utilize the same or different filtering sub-blocks 74 for filtering at different frequencies. Clipping and filtering techniques for CFR may cause anomalies in the intermediate signal 66 and/or output signal 64, such as harmonic spurs and/or increased power leakage from an assigned channel 86 (e.g., band of frequencies 80) to adjacent channels 88. As discussed further below, the DFS block 70 may help reduce the extent of such anomalies.

In some embodiments, the clip and filter block 68 may or may not include differential circuitry 90, including combination logic 92 and/or delay logic 94. Clip and filter blocks 68 utilizing differential circuitry 90 may perform clipping (e.g., via the clipping sub-block 72) on the input signal 62 or intermediate signal 66 and perform filtering (e.g., via the filtering sub-block 74) on a clipping error 96 determined from a combination (e.g., via combination logic 92) of, such as a difference between, the input signal 62 or intermediate signal 66 and the clipped signal 98. The filtered clipping error 100 (e.g., clipping error 96 with filtering applied) may be combined (e.g., via combination logic 92) with (e.g., added to) the input signal 62 or intermediate signal 66 to generate the output signal 64 or another intermediate signal 66. Moreover, in some embodiments, delay logic 94 may be implemented to temporally align the input signal 62 or intermediate signal 66 with the clipped signal 98 and filtered clipping error 100 for the combinations (e.g., via the combination logic 92) to account for processing times within the clipping sub-block 72 and/or filtering sub-block 74. In some scenarios, by performing filtering on the clipping error 96, a lower order filter may be utilized for equal and/or higher stopband suppression relative to performing filtering on the clipped signal 98. Moreover, as should be appreciated, in embodiments without or not utilizing the differential circuitry 90, the filtering sub-block 74 may perform filtering on the clipped signal 98, and the intermediate signal 66 or output signal 64 produced by the clip and filter block 68 may be the clipped signal 98 with filtering applied (e.g., a clipped, filtered signal).

As discussed herein, the clipping and filtering techniques for CFR may cause anomalies in the intermediate signal 66 and/or output signal 64 that increase the error vector magnitude (EVM), which may reduce signal quality, and/or degrade (e.g., decrease) an adjacent carrier leakage ratio (ACLR), which may increase transmissions outside of a desired band (e.g., outside of an assigned channel 86 and into an adjacent channel 88). For example, clipping and filtering may generate spurs within the output signal 64, which may be exasperated at low and/or non-centered (e.g., about a reference frequency 82) resource block (RB) allocations. Returning to FIG. 5, in some embodiments, the DFS block 70 may be implemented in conjunction with one or more clip and filter blocks 68 to improve the spectral emissions of the output signal 64.

The DFS block 70 may shift the frequency spectrum of the input signal 62 and/or an intermediate signal 66 of the CFR block 60 to be centered (e.g., in the frequency domain) around a reference frequency 82 (e.g., 0 Hz, the carrier frequency, band frequency, or other suitable frequency). For example, the DFS block 70 may include a coordinate rotation digital computer (CORDIC) or other circuitry or algorithm to provide a frequency shift to the input signal 62 and/or an intermediate signal 66 such that the PSD 78 of the signal is approximately balanced (e.g., equal in the average) on either side of the reference frequency 82. As should be appreciated, while depicted in FIG. 5 as having multiple clip and filter blocks 68 both before and after the DFS block 70, the CFR block 60 may include a CFR-DFS set 102 including a single DFS block 70 and one or more clip and filter blocks 68 before and/or after the single DFS block 70. Moreover, the CFR-DFS set 102 may include any suitable arrangement of a DFS block 70 and one or more clip and filter blocks 68 in series. Indeed, depending on an ordering of the DFS block 70 and a clip and filter block 68, the output signal 64 or an intermediate signal 66 may exhibit different characteristics. For example, in some scenarios, when implemented after one or more clip and filter blocks 68, the DFS block 70 may reduce (e.g., correct) shifts of the spectral components of an intermediate signal 66 into different bands (e.g., adjacent channels 88) that may be generated due to the clipping and/or filtering, thus, improving (e.g., increasing) ACLR. Additionally, in some scenarios, the use of the DFS block 70 before one or more clip and filter blocks 68 may suppress harmonics (e.g., spurs) that may otherwise be generated due to the clipping and/or filtering, thus, improving (e.g., reducing) EVM. Furthermore, in some embodiments, both improvements may be realized by implementing the DFS block 70 between one or more sets of clip and filter blocks 68. For example, a CFR-DFS set 102 may include one or more clip and filter blocks 68 before the DFS block 70 and one or more additional clip and filter blocks 68 after the DFS block 70. As should be appreciated, one or more clip and filter blocks 68 may be utilized before and/or after the DFS block, and different amounts and/or relative positions of the clip and filter blocks 68 and DFS blocks 70 may be utilized depending on implementation.

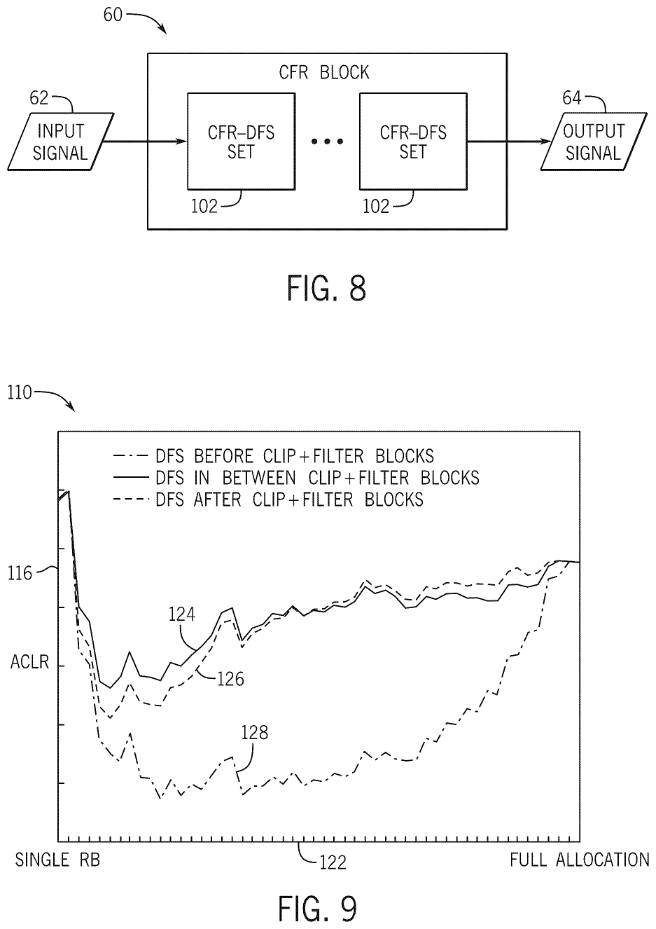

Additionally, in some embodiments, the CFR block 60 may utilize multiple CFR-DFS sets 102 in series, as shown in FIG. 8. For example, in some embodiments, multiple DFS blocks 70 (e.g., utilized in separate CFR-DFS sets 102) may perform frequency shifts about different reference frequencies 82 (e.g., carrier frequencies, band frequencies), such as based on the allocation. For example, the different DFS blocks 70 may be utilized to perform CFR on a per-component carrier (CC) basis, such as on an input signal 62 that is carrier-aggregated. As such, frequency-specific CFR may be performed in stages (e.g., series of CFR-DFS set 102) for improved EVM, ACLR, and/or PAPR. Moreover, in some scenarios, performing per-CC (e.g., frequency-specific) CFR may allow for reduced complexity of the associated filters of the filtering sub-blocks 74.

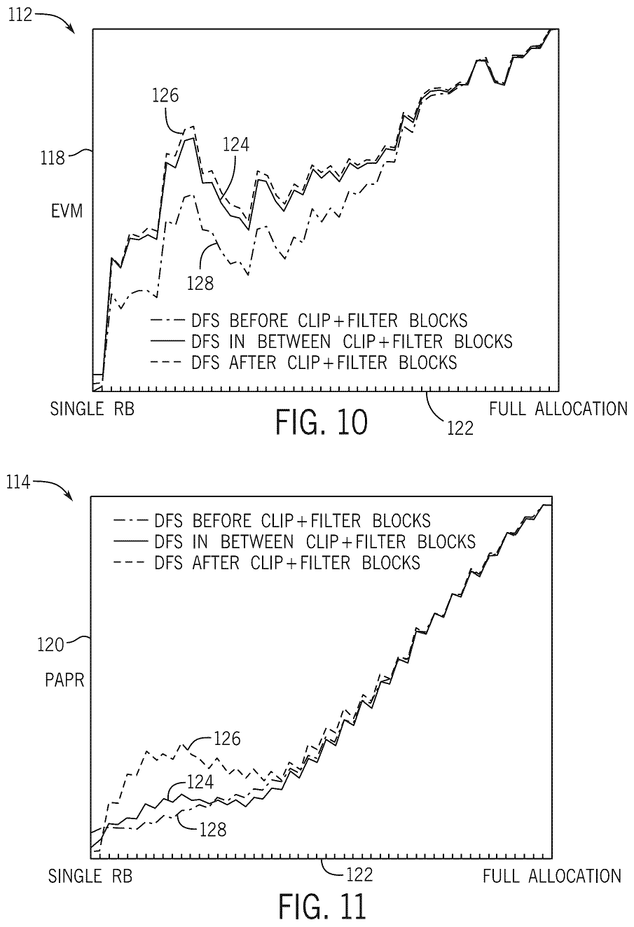

As discussed above, different arrangements (e.g., linear combinations with respect to the flow of data) of one or more clip and filter blocks 68 and a DFS block 70 in a CFR-DFS set 102 may be utilized to achieve different benefits in the output signal 64. To help illustrate, FIGS. 9-11 are graphs 110, 112, and 114 of ACLRs 116, EVMs 118, and PAPRs 120, respectively over a sweep of RB allocations 122 (e.g., from a single RB to full allocation of RBs) for different arrangements of the CFR block 60. As should be appreciated, the graphs 110, 112, and 114 are given as illustrative examples and should not be considered limiting in any fashion. In some scenarios, a first arrangement 124 of a CFR-DFS set 102 having a DFS block 70 between the clip and filter blocks 68 may have an improved (e.g., higher) ACLR 116, at lower RB allocations 122, compared to a second arrangement 126 having a CFR-DFS set 102 with the DFS block 70 implemented after a clip and filter block 68 or a third arrangement 128 having a CFR-DFS set 102 with the DFS block 70 implemented before the clip and filter block 68. As should be appreciated, different arrangements (e.g., arrangements 124, 126, and 128) may be better suited for different scenarios (e.g., allocations 122) or desired constraints (e.g., ACLR 116, EVM 118, and/or PAPR 120). As such, the arrangement of the CFR-DFS set 102 and/or number of CFR-DFS sets 102 may vary depending on implementation.

Furthermore, in some embodiments, the arrangement of the CFR-DFS set(s) 102 may be dynamically adjustable to optimize the output signal 64 for a given scenario. For example, one or more clip and filter blocks 68 before and/or after a DFS block 70 within a CFR-DFS set 102 may be enabled or disabled to change the arrangement. Moreover, one or more multiplexers may be utilized to alter the ordering of the clip and filter block(s) and the DFS block 70 for the CFR-DFS set(s) 102.

Furthermore, as discussed herein, the DFS block 70 may shift the spectrum of the input signal 62 and/or an intermediate signal 66 in the frequency domain to be centered about a reference frequency 82. As such, in some embodiments, the output signal 64 may undergo an inverse frequency shift (e.g., opposite the DFS of the DFS block 70) to return the output signal 64 to the frequency 80 of the input signal 62. As should be appreciated, the inverse frequency shift may occur as a block of the signal processing circuitry 52 or be incorporated into other components, such as the DAC 40 and/or modulator 42. Moreover, for embodiments with multiple DFS blocks 70 (e.g., multiple CFR-DFS set(s) 102), the inverse frequency shift may include an aggregated inverse frequency shift equivalent to the inverse frequency shift of the combined frequency shifts of the multiple DFS blocks 70.

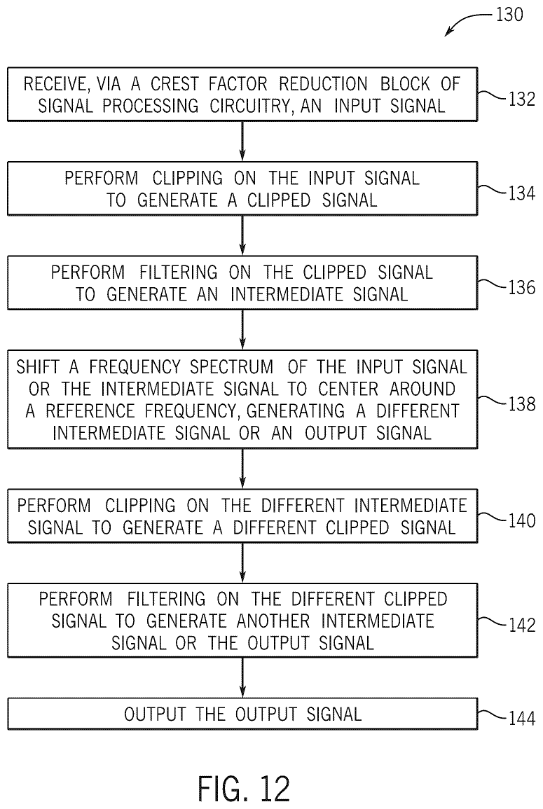

FIG. 12 is a flowchart of an example process 130 for performing CFR via the CFR block 60. The CFR block 60 of the signal processing circuitry 52 may receive an input signal 62 (process block 132), such as to perform CFR thereon. In some embodiments, the CFR block 60 may perform clipping (e.g., via a clipping sub-block 72) on the input signal 62 to generate a clipped signal 98 (process block 134) and perform filtering (e.g., via a filtering sub-block 74) on the clipped signal 98 to generate an intermediate signal 66 (process block 136). Additionally, the CFR block 60 may shift (e.g., via a DFS block 70) a frequency spectrum of the input signal 62 or the intermediate signal 66 to center around a reference frequency 82, generating a different intermediate signal or an output signal 64 (process block 138). As should be appreciated, whether the CFR block 60 shifts the input signal 62 or the intermediate signal 66 and generates the different intermediate signal 66 or the output signal 64 may depend on the arrangement of the CFR-DFS set 102 of the DFS block 70. Furthermore, in some embodiments, the CFR block 60 may perform clipping (e.g., via a clipping sub-block 72) on the different intermediate signal 66 to generate a different clipped signal 98 (process block 140), and filtering may be performed on the different clipped signal 98 to generate another intermediate signal 66 (e.g., for further processing via the CFR block 60, such as via one or more additional clip and filter block(s) and/or CFR-DFS set(s) 102) or the output signal 64 (process block 142). As such, the CFR block 60 may output the output signal 64 having applied CFR to the input signal 62 to achieve a reduced PAPR (process block 144).

The specific embodiments described above have been shown by way of example, and it should be understood that these embodiments may be susceptible to various modifications and alternative forms. Moreover, although the above flowchart is shown in a given order, in certain embodiments, process/decision blocks may be reordered, altered, deleted, and/or occur simultaneously. Additionally, the flowchart is given as an illustrative tool and further decision and process blocks may also be added depending on implementation. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device comprising:
crest factor reduction circuitry comprising a clip and filter block and a frequency shift block, the crest factor reduction circuitry configured to receive an input signal and to generate an output signal based on the input signal, the output signal having a reduced peak-to-average power ratio (PAPR) relative to the input signal; and
a transmitter coupled to the crest factor reduction circuitry and configured to transmit a radio frequency (RF) signal based on the output signal.

2. The electronic device of claim 1, wherein the input signal comprises a digital signal, and the frequency shift block comprises a digital frequency shift (DFS) block.

3. The electronic device of claim 2, wherein the DFS block comprises a coordinate rotation digital computer (CORDIC).

4. The electronic device of claim 1, wherein the input signal comprises a frequency modulated signal, and wherein the frequency shift block is configured to shift a frequency spectrum of the frequency modulated signal to be centered about a reference frequency.

5. The electronic device of claim 1, wherein the clip and filter block comprises a clipping sub-block configured to clip an amplitude of the input signal according to a clipping threshold to generate a clipped signal.

6. The electronic device of claim 5, wherein the clip and filter block comprises a filtering sub-block configured to filter the clipped signal.

7. The electronic device of claim 5, wherein the clip and filter block is configured to determine a clipping error based on a difference between the input signal and the clipped signal, the clip and filter block comprising a filtering sub-block configured to filter the clipping error to generate a filtered clipping error, and the clip and filter block being configured to combine the filtered clipping error with the input signal to generate an intermediate signal and to provide the intermediate signal to the frequency shift block.

8. The electronic device of claim 1, wherein the clip and filter block comprises a first clip and filter block, the crest factor reduction circuitry comprising a set of blocks comprising the first clip and filter block disposed before the frequency shift block, relative to a flow of data of the input signal through the crest factor reduction circuitry, and a second clip and filter block disposed after the frequency shift block.

9. The electronic device of claim 1, wherein the crest factor reduction circuitry comprises a plurality of sets of blocks, wherein each set of blocks of the plurality of sets of blocks comprises one or more respective clip and filter blocks and a respective frequency shift block, a set of blocks of the plurality of sets of blocks comprising the clip and filter block and the frequency shift block.

10. The electronic device of claim 9, wherein the respective frequency shift block of each set of blocks of the plurality of sets of blocks is configured to shift a frequency spectrum of the input signal or an intermediate signal corresponding to an altered version of the input signal to be centered about a different frequency.

11. The electronic device of claim 10, wherein the different frequency of each set of blocks of the plurality of sets of blocks corresponds to a different carrier frequency of the RF signal.

12. A method comprising:
receiving, via clip and filter circuitry of crest factor reduction circuitry, a first signal corresponding to data to be transmitted via transmission circuitry coupled to the crest factor reduction circuitry;
clipping and filtering, via the clip and filter circuitry, the first signal to generate a second signal;
shifting, via frequency shift circuitry of the crest factor reduction circuitry, a frequency spectrum of the second signal to generate a third signal;
clipping and filtering, via the clip and filter circuitry, the third signal to generate a fourth signal; and
outputting the fourth signal.

13. The method of claim 12, wherein the second signal comprises a frequency modulated signal, and wherein the frequency shift circuitry is configured to shift the frequency spectrum of the frequency modulated signal to be centered about a reference frequency.

14. The method of claim 12, wherein the fourth signal is output to second clip and filter circuitry of the crest factor reduction circuitry, the method comprising:
clipping and filtering, via the second clip and filter circuitry, the fourth signal to generate a fifth signal;
shifting, via second frequency shift circuitry of the crest factor reduction circuitry, a second frequency spectrum of the fifth signal to generate a sixth signal; and
outputting the sixth signal.

15. The method of claim 12, wherein the frequency shift circuitry comprises a coordinate rotation digital computer (CORDIC).

16. The method of claim 12, wherein the clip and filter circuitry comprises:
a clipping sub-block configured to clip an amplitude of the first signal according to a clipping threshold to generate a clipped signal; and
a filtering sub-block configured to filter the clipped signal.

17. The method of claim 16, wherein the clip and filter circuitry comprises a plurality of sets of sub-blocks in series, wherein each set of sub-blocks of the plurality of sets of sub-blocks comprises a respective clipping sub-block and a respective filtering sub-block.

18. A non-transitory, machine-readable medium comprising instructions that, when executed by one or more processors, cause the one or more processors to:
receive a first signal corresponding to data to be transmitted via transmission circuitry coupled to the one or more processors;
clip and filter the first signal to generate a second signal;
shift a frequency spectrum of the second signal to generate a third signal;
clip and filter the third signal to generate a fourth signal; and
output the fourth signal.

19. The non-transitory, machine-readable medium of claim 18, wherein the first signal or the third signal is clipped and filtered using a plurality of clipping stages and a plurality of filtering stages.

20. The non-transitory, machine-readable medium of claim 18, wherein the instructions, when executed by the one or more processors, cause the one or more processors to clip and filter the first signal to generate the second signal by:
clipping an amplitude of the first signal according to a clipping threshold to generate a clipped signal;
determining a clipping error based on a difference between the first signal and the clipped signal;
filtering the clipping error to generate a filtered clipping error; and
combining the filtered clipping error with the first signal to generate the second signal.
